(19) United States
(12) Patent Application Publication
(10) Pub. No.: US 2025/0064057 A1
(43) Pub. Date: Feb. 27, 2025

(54) HARMFUL ALGAL BLOOM MITIGATION

(71) Applicant: Mote Marine Laboratory, Inc., Sarasota, FL (US)

(72) Inventors: Cynthia Heil, Sarasota, FL (US); Emily Hall, Sarasota, FL (US); Vince Lovko, Sarasota, FL (US); Rich Pierce, Sarasota, FL (US); John Langan, Sarasota, FL (US)

(21) Appl. No.: 18/814,440

(22) Filed: Aug. 23, 2024

Related U.S. Application Data
(60) Provisional application No. 63/534,271, filed on Aug. 23, 2023.
(60) Provisional application No. 63/534,279, filed on Aug. 23, 2023.
(60) Provisional application No. 63/534,285, filed on Aug. 23, 2023.
(60) Provisional application No. 63/541,866, filed on Oct. 1, 2023.
(60) Provisional application No. 63/649,284, filed on May 17, 2024.

(51) Int. Cl. A01N 35/02; A01N 25/06; A01N 65/48; A01P 13/00

(52) U.S. Cl. CPC A01N 35/02; A01N 25/06; A01N 65/48; A01P 13/00

(57) ABSTRACT

A method for harmful algal bloom (HAB) mitigation is provided. The method may include preparing a HAB mitigation substance comprising a curcuminiod substance, and applying the HAB mitigation substance to a HAB to destroy algal cells within the HAB and prevent or inhibit release of toxins from the algal cells.

### CROSS-REFERENCE TO RELATED APPLICATIONS

This application claims priority to U.S. Provisional Application No. 63/534,271, filed on Aug. 23, 2023, U.S. Provisional Application No. 63/534,279, filed on Aug. 23, 2023, U.S. Provisional Application No. 63/534,285, filed on Aug. 23, 2023, U.S. Provisional Application No. 63/541,866, filed on Oct. 1, 2023, and U.S. Provisional Application No. 63/649,284 filed May 17, 2024, the disclosures of which are incorporated herein by reference.

### TECHNICAL FIELD

The subject matter disclosed herein is generally directed to a method for mitigating Harmful Algal Bloom (HAB) conditions by reducing/eliminating the cellular organisms, such as, for example, Karenia brevis that cause HABs.

### BACKGROUND

Harmful algal blooms (HABs) of both fresh and marine origin have wreaked havoc in locations including the state of Florida dating back hundreds of years, with impacts documented as early as the 1500s. These HABs often have significant ecological, economical, and human health impacts, and HAB events have been increasing in severity alongside increasing population growth, rapid development, cutrophication, and climate change occurring in this region. Among Florida HABs, blooms of the toxic marine dinoflagellate Karenia brevis are perhaps the most severe and formidable, due to the frequency and geographic spread of these blooms, and the complex natural and anthropogenic drivers that make these blooms challenging to mitigate. First officially identified and described in 1948, K. brevis blooms occur in the eastern Gulf of Mexico almost annually and produce brevetoxins that cause respiratory irritation, neurotoxic shellfish poisoning, and extensive marine and coastal organism mortalities. Karenia brevis blooms can also cause significant socio-economic problems for the state of Florida, due to the impact on fisheries and the degradation of shorelines and coastal waters.

Given the severity of these blooms, efforts are being made to develop potential mitigation strategies and technologies. Public education, monitoring and reporting programs, and the implementation of policies to reduce sources of nutrient pollution serve to reduce the economic and health impacts of blooms, and attempt to reduce the severity of blooms before they occur. However, such efforts are insufficient to address the full scope of the problem. Given the challenges of implementing comprehensive nutrient reduction strategies, it is desirable to develop further methods of reducing the impact of HAB events by, for example, attacking the K. brevis cells and toxins during bloom development. Past attempts to control blooms chemically, along with other mitigation strategies, have so far been unsuccessful, due to issues including high costs, poor scalability, elevation of other pollutants, and detrimental impacts on non-targeted species. Accordingly, there remains a need for further innovation to mitigate HAB events.

### SUMMARY OF SOME EXAMPLE EMBODIMENTS

According to some example embodiments, a method for harmful algal bloom (HAB) mitigation is provided. The method may comprise preparing a HAB mitigation substance comprising a curcuminiod substance, and applying the HAB mitigation substance to a HAB to destroy algal cells within the HAB and prevent or inhibit release of toxins from the algal cells.

According to some example embodiments, another method for mitigating harmful algal blooms comprises configuring a curcumin stock solution to allow for the solubility of curcumin in seawater, flocculating the curcumin stock solution with modified clay minerals to allow for the curcumin to interact down the water column, dispersing the flocculated curcumin stock solution and modified clay minerals into seawater. Further, the curcumin stock solution may be configured with deionized water, ozonated and filtered (20 μm) seawater, ozonated and filtered seawater and heating (40° C. for 1 h), ozonated and filtered seawater with 0.001% ethanol additions, ozonated and filtered seawater with 0.004% ethanol, or 99.5-100% ethanol. Further still, the clay minerals may be kandite, illite, smectite, or vermiculite. Still again, the dispersion process may involve surface vessel spraying, airborne spraying, or submerged vessel spraying. Further again, the curcumin used may be selected from turmeric extract powder, zedoary root, or hydrogenated form of Curcuma longa.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 depicts the organic compound structure of curcumin, according to some example embodiments.

FIG. 2 depicts the percent reduction of low-dose curcumin treatments on K. brevis cell abundance relative to control, according to some example embodiments.

FIG. 3 depicts percent reduction of high-dose curcumin treatments on K. brevis cell abundance relative to control, according to some example embodiments.

FIG. 4 depicts mean and standard error of percent reduction of curcumin treatments on K. brevis cell abundance relative to control by sample event, according to some example embodiments.

FIG. 5 depicts mean and standard error of percent reduction of curcumin treatments on K. brevis cell abundance relative to control by sample event for white curcumin only, according to some example embodiments.

FIG. 6 depicts percent reduction of low-dose curcumin treatments on K. brevis total toxins relative to control, according to some example embodiments.

FIG. 7 depicts percent reduction of high-dose curcumin treatments on K. brevis total toxins relative to control, according to some example embodiments.

FIG. 8 depicts mean and standard error of percent reduction of curcumin treatments on K. brevis toxins relative to control by sample event, according to some example embodiments.

FIG. 9 depicts total brevetoxin concentrations in low-dose treatments over time divided by congener: BTX-1, BTX-2, BTX-3, and BTX-B5, according to some example embodiments.

FIG. 10 depicts total brevetoxin concentrations in high-dose treatments over time divided by congener: BTX-1, BTX-2, BTX-3, and BTX-B5, according to some example embodiments.

FIG. 11 depicts the laboratory experimental design, according to some example embodiments.

FIG. 12 depicts toxin compound cone voltage optimization, according to some example embodiments.

FIG. 13 depicts a table indicating the abundance of K. brevis throughout the experiments up to 96 hours, according to some example embodiments.

FIG. 14 depicts a table 1400 indicating Dunn's pairwise nonparametric tests of percent reduction of curcumin treatments on K. brevis cell abundance relative to control 2 hours after application, according to some example embodiments.

FIG. 15 depicts a table 1500 indicating Dunn's pairwise nonparametric tests of percent reduction (% R) of curcumin treatments on K. brevis cell abundance relative to control 4 hours after application, according to some example embodiments.

FIG. 16 depicts a table 1600 indicating Dunn's pairwise nonparametric tests of percent reduction (% R) of curcumin treatments on K. brevis cell abundance relative to control 6 hours after application, according to some example embodiments.

FIG. 17 depicts a table 1700 indicating Dunn's pairwise nonparametric tests of percent reduction (% R) of curcumin treatments on K. brevis cell abundance relative to control 24 hours after application, according to some example embodiments.

FIG. 18 depicts a table 1800 indicating Dunn's pairwise nonparametric tests of percent reduction (% R) of curcumin treatments on K. brevis cell abundance relative to control 48 hours after application, according to some example embodiments.

FIG. 19 depicts a table 1900 indicating Dunn's pairwise nonparametric tests of percent reduction (% R) of curcumin treatments on K. brevis cell abundance relative to control 72 hours after application, according to some example embodiments.

FIG. 20 depicts a table 2000 indicating Dunn's pairwise nonparametric tests of percent reduction (% R) of curcumin treatments on K. brevis cell abundance relative to control 96 hours after application, according to some example embodiments.

FIG. 21 depicts a table 2100 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 4 hours after application, according to some example embodiments.

FIG. 22 depicts a table 2200 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 6 hours after application, according to some example embodiments.

FIG. 23 depicts a table 2300 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 24 hours after application, according to some example embodiments.

FIG. 24 depicts a table 2400 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 48 hours after application, according to some example embodiments.

FIG. 25 depicts a table 2500 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 72 hours after application, according to some example embodiments.

FIG. 26 depicts a table 2600 indicating Dunn's pairwise nonparametric tests of percent reduction (% R) of curcumin treatments on K. brevis toxins (sum of analogs BTX-1, BTX-2, BTX-3, and BTX-B5 in ng/L) relative to control 96 hours after application, according to some example embodiments.

FIG. 27 depicts a table 2700 indicating Average (SE) water quality conditions in each test, according to some example embodiments.

FIG. 28 depicts a table 2800 indicating Average (SE) nutrient conditions in the 3 and 5 mg/L curcumin tests, according to some example embodiments.

The figures herein are for illustrative purposes only and are not necessarily drawn to scale.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “polymer” refers to molecules made up of monomers repeat units linked together. “Polymers” are understood to include, but are not limited to, homopolymers, copolymers, such as for example, block, graft, random and alternating copolymers, terpolymers, etc. and blends and modifications thereof. “A polymer” can be a three-dimensional network (e.g., the repeat units are linked together left and right, front and back, up and down), a two-dimensional network (e.g., the repeat units are linked together left, right, up, and down in a sheet form), or a one-dimensional network (e.g., the repeat units are linked left and right to form a chain). “Polymers” can be composed, natural monomers or synthetic monomers and combinations thereof. The polymers can be biologic (e.g., the monomers are biologically important (e.g., an amino acid), natural, or synthetic.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

According to some example embodiments, methods, substances, systems, and apparatuses are described herein that prepare or apply a HAB mitigation substance, such as, a curcuminoid substance (e.g., curcumin), to diminish or destroy the algal cells of a HAB. In this regard, such a HAB mitigation substance may operate to diminish or destroy the cells of Karenia brevis HABs, and thereby inhibit or prevent to release of harmful brevetoxins from algal cells of the HAB. In some example embodiments, phytochemical curcumin, (1E,6E)-1,7-Bis (4 (hydroxy-3-methoxyphenyl)-1,6-heptadiene-3,5-dione) may be a HAB mitigation substance or a component of a HAB mitigation substance. Some benefits of using, for example, a phytochemical curcumin implementation include low cost, high effectiveness on the mitigation of other harmful algae species and toxins, and other benefits to marine fish. Phytochemical curcumin is a primary bioactive compound found in turmeric (Curcuma longa), a member of the ginger family (Zingiberaceae). Curcumin has been found to be effective in controlling animal and agricultural pests, and is an increasingly popular health supplement in human diets due to its anti-inflammatory, anti-angiogenic, antioxidant and anticancer effects.

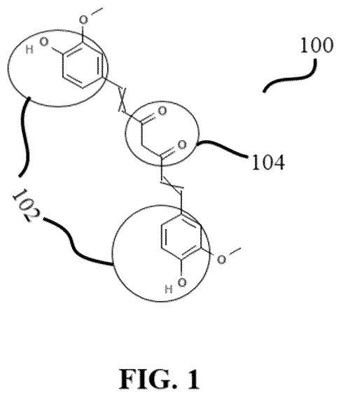

As shown in FIG. 1, Curcumin 100 has an organic compound structure comprising three reactive functional groups: one diketone moiety 104 and two phenolic groups 102. These functional groups of curcumin may facilitate destructive interaction with algal cells to, for example, thin or fracture the cell wall to destroy the cell. Chemical reactions associated with the biological activity of curcumin include hydrogen donation reactions that can lead to oxidation of the curcumin, reversible and irreversible nucleophilic addition reactions (Michael reactions), hydrolysis, degradation and enzymatic reactions. These and others may play a significant role in the different biological activities of curcumin and the ability of curcumin, and other curcuminoid substances, to mitigate HAB events.

While curcumin is one example target substance to destroy algal cells as part of a HAB mitigation substance, other target substances may also be used. For example, other linear diarylheptanoids may be used. In this regard, demethoxycurcumin and bisdemethoxycurcumin may additionally or alternatively be used as target substances for inclusion in a HAB mitigation substance. One of skill in the art would appreciate that example embodiments provided herein that reference curcumin may alternatively or additionally reference the other target substances referenced herein.

The use curcumin to diminish or destroy the algal cells in a HAB has be tested and realized surprising effectiveness. To test the efficacy of curcumin in mitigating K. brevis cells and associated toxins, multiple laboratory studies have been conducted with food-grade curcumin (a mixture of all curcuminoids found in turmeric) to determine the efficacy of curcumin as a HAB mitigation substance for K. brevis blooms. Studies included tests on K. brevis cell and toxin reduction, experiments to identify optimal treatment dosages and the methods of preparation, and potential impacts of treatments on measures of water quality, including nutrients, dissolved oxygen, turbidity, and color.

Numerous laboratory experiments have been performed to assess the effects of curcumin on K. brevis. Studies conducted in 1.5 L beakers for 48 h were performed to determine the efficacy of curcumin on the reduction of cultured K. brevis cells and the associated brevetoxins, followed by studies performed in a 10 L aquaria for a minimum of 48 h, and then up to 336 h to continue examination of the effects of curcumin on K. brevis and any residual effects on water quality. Beaker experiments were conducted on the benchtop in the laboratory under ambient fluorescent light, while aquaria experiments were conducted under a 12 h light-dark cycle at 213±12 μmol/m²/s (mean±standard error [SE]). Experiments were conducted using turmeric extract powder, an orange curcumin powder, supplied from bulk supplements. Studies were conducted with a white curcumin product (Zedoary Root (Curcuma zedoaria) and CuroWhite™ (hydrogenated form of Curcuma longa) to address issues of orange water color change when used in the field. In the experiments, treatment groups were replicated in duplicate at a minimum, and experiments were conducted with a control group (K. brevis+seawater) to account for container-related effects.

According to some example embodiments, methods may be implemented to increase the water or seawater solubility of a target substance (e.g., curcumin) to facilitate penetration of HAB mitigation substance down the water column. Since algal cells of a HAB can be present at differing depths of the water column, a soluble HAB mitigation substance is beneficial to have an impact down the water column, relative to one that may only treat the surface of the water due to poor solubility. As curcumin is not 100% soluble in seawater, HAB mitigation substances in the form of curcumin stock solutions with improved solubility may be prepared and utilized. In this regard, for example, curcumin stock solutions may be made using a number of example methods. In one example method, curcumin (e.g., >95% curcuminoid, Bulk Supplements) may be added to deionized water, and the solution may be subjected to vigorously mixing. In another example method, curcumin may be mixed with ozonated and filtered (20 μm) seawater and vigorously mixed. In another example method, curcumin may be mixed with ozonated and filtered seawater and heated (e.g., to about 40° C. for about 1 h). In another example method, curcumin may be mixed with ozonated and filtered seawater with 0.001% ethanol additions. Further, in another method, curcumin may be mixed with ozonated and filtered seawater with 0.004% ethanol. In another example method, curcumin may be mixed with 99.5-100% ethanol. Further, according to some example embodiments, various combinations of these methods and components thereof may be used. According to some example embodiments, the results of such methods may be stored in opaque containers or in a dark location to prevent photodegradation.

In some example embodiments, a target substance, such as, curcumin, may, additionally or alternatively, be subjected to a flocculation distribution process to form a HAB mitigation substance. In this regard, the HAB mitigation substance may take the form of a flocculant with the target substance (e.g., curcumin) mixed or infuse therewith to distribute the target substance throughout the flocculant. The flocculant may comprise a coagulant, such as a chemical coagulant (which may or may not be combined with various polymers), that facilitates bonding between particles of flocculant to entrap the distributed or infused target substance in the flocculant.

A flocculant, according to some example embodiments, may operate to attract substances in, for example, a liquid media and attach to such substances. According to some example embodiments, the attraction forces may be the result of opposite charges due to the presence of, for example, charged ions in the flocculant. According to some example embodiments, algal cells may have an opposite charge from the flocculant, and therefore the algal cells may be attracted to the flocculant. Since the flocculant may be infused with a target substance, such as, for example, curcumin, the flocculant may operate to attract the algal cells into interaction with the target substance to destroy the algal cell. The attraction causes a collection of particles to clump and form a froc. Additionally, since some flocculants may have a density that causes the flocculants to sink in, for example, seawater, the curcumin-infused flocculant HAB mitigation substance may sink to the seabed, having, in some instances, less ecological impact.

Various flocculants may be used in according to some example embodiments. For example, clay minerals, modified clays, polymers, biopolymers, or the like may be used. Additionally or alternatively, according to some example embodiments, biochar, chitin, chitosan, or other flocculants may be used. Clay minerals that may be used as flocullants may belong to the phyllosilicate family of minerals, which are characterized by layered structures composed of polymeric sheets of silica tetrahedra attached with octahedral sheets. There are four major groups of clay minerals (kandite, illite, smectite, and vermiculite), any of which may be used as a flocculant, according to some example embodiments. In some example embodiments, modified clay may be used. Modified clay may include other materials such as inorganic polymers (e.g. polyaluminum chloride or other chlorides) added to the clay mineral mixture. According to some example embodiments, sodium bentonite clays or calcium bentonite clays may be used as flocculant.

A HAB mitigation substance that comprises a flocculant may take the form of a slurry. For example, target substance infused clay platelets may be present within slurry for dispersion into a HAB.

Thus, according to some example embodiments, to form a HAB mitigation substance, a target substance, such as a substance having a percent of a curcuminoid (e.g., curcumin) may be subjected to a solubility process to increase the solubility of the target substance and form a soluble target substance as a HAB mitigation substance. As mentioned above, such a solubility process may include mixing the target substance with, for example, deionized water, ozonated water, filtered water or seawater, ethanol, combinations thereof, or the like. In some example embodiments, the solubility process may also include heating the mixed target substance to a defined temperature for certain duration of time (e.g., to about 40° C. for about 1 h). According to some example embodiments, the resulting soluble target substance may be used directly as a HAB mitigation substance for application on an HAB bloom. In such example embodiments, the resulting soluble target substance may be stored in an opaque container to prevent photodegradation prior to application.

According to some example embodiments, a flocculant input substance, which may be a target substance (e.g., curcumin) or a soluble target substance formed via the solubility process described above, may be subjected to a flocculation distribution process to infuse the flocculant input substance into a flocculant to form a HAB mitigation substance.

For HAB mitigation, various dispersion techniques may be used to spread or disperse the HAB mitigation substance in the HAB, according to some example embodiments. According to some example embodiments, an apparatus may be employed that is configured to spray a HAB mitigation substance, for example, in the form of modified clay (MC) particles, on the water surface where a HAB has occurred. The clay particles then flocculate (to aggregate or clump) with algal cells and expose the cells to the target substance therein (e.g., curcumin). The flocculated masses may then sink to the bottom of the water column to settle.

The effectiveness of flocculant solutions to flocculate algal cells depends on the size of the flocculant (e.g., clay) particles and the density of the particle spray mixture. The total interaction energy between the flocculant and algal cells at close range may cause the flocculant to self-flocculate, decreasing its ability to remove the harmful microalgae. The dosage of flocculant (e.g., modified clay) may also impact the self-flocculation proportion by interfering with the collision between the flocculant and algal cells.

Various dispersal methods for HAB mitigation substances may be used. Airborne spraying from an aircraft or and surface vessel spraying from a ship are two methods. A third method is more complicated and involves a remotely operated spraying vehicle. A tank that serves as a reservoir may be integrated into or attached onto the body of a vehicle, such as, a remotely operated sailing vehicle (ROV). The tank includes a pump and valve system that employs a submersible pump to draw ambient seawater into the reservoir. This in turn forces the HAB mitigation substance out of the reservoir. Powered by the ROV batteries and activated by the ROV's circuitry for opening and closing the grabber arm. When activated, the pump and valve will be turned on. The tank includes a manifold system that will allow several types of HAB mitigation substances that might differ in density, viscosity, and acidity while allowing the pump and valve system to remain the same. The tank pump and valve will release the onboard HAB mitigation substance in front of the ROV thrusters to facilitate dispersal into the water column. The pump is designed to produce a flow rate commensurate with the forward momentum of the ROV at low speed. To optimize the distribution of the mitigation solution, the release point of the mitigation solution can vary from in front of one thruster, lower port side to the center of the aft thrusters. The valve system is variable speed to account for ROV speed and is able to release the liquid at a rate equal to the pump input.

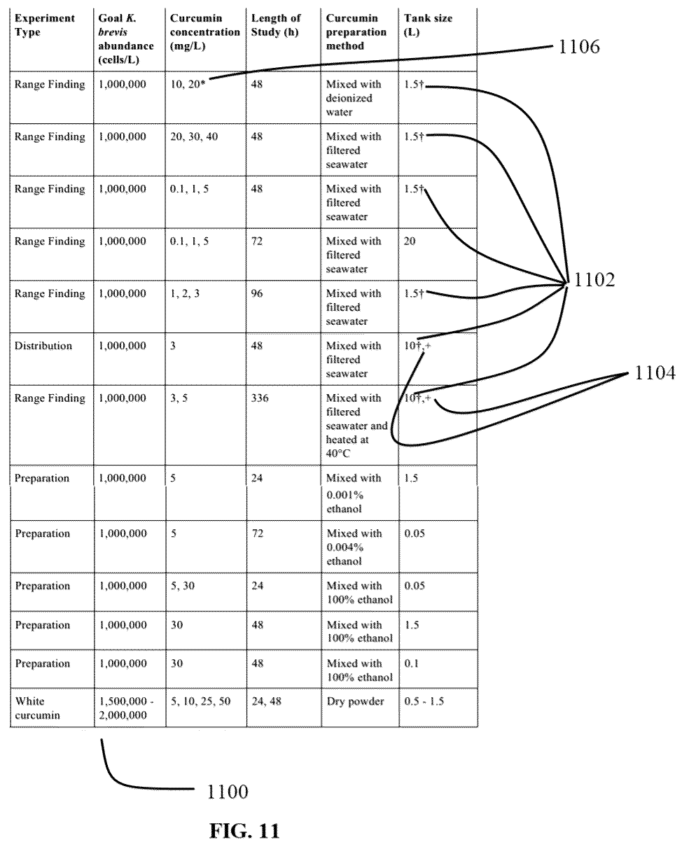

Karenia brevis (Mote New Pass Clone/CCMP 2228) was cultured in modified L1 media (omission of SiO₄ additions) at 24° C., salinity 32-34 ppt, and a 12 h L:D cycle at 50-60 μmol/m²/s. Cultures of 20.0-30.0×10⁶ cells/L were diluted with filtered (Whatman GFF) seawater collected from Mote's New Pass dock (salinity, 33 ppt) immediately prior to the start of each experiment to a final target cell abundance of ˜1.0×10⁶ cells/L. For each experiment, diluted cultures of K. brevis were added to triplicate cleaned (10% HCl followed by repeated Milli-Q rinses) glass containers (size depending on experiment, see FIG. 11, table 1100), covered lightly with parafilm and allowed to acclimate at room temperature for 1-2 h. In FIG. 11, 1102 represents where brevetoxin was assessed and 1104 represents where dissolved nutrients (DNH4-N, DNO2,3-N, DPO4-P) were evaluated, and 1106 represents where no water quality parameters were evaluated. Curcumin stock solution was added to each treatment container (0.05, 0.1, 1.5, or 10 L depending on the experiment) by gently pouring over the surface of each treatment container. Samples of K. brevis live cell counts were collected at T0 (before curcumin addition), T2 (2 h post curcumin addition), T4 or T6 (4-6 h post curcumin addition), T24 (24 h post curcumin addition), then every 24 h after. In experiments where brevetoxins were analyzed, water samples were typically collected at T0, T24, and T48. Water quality (temperature, salinity, dissolved oxygen, pH) were measured in each treatment at each time point, and when nutrients were analyzed, samples were collected at each time point. Nutrients (dissolved ammonium, nitrate-nitrite, and phosphate) were monitored in experiments in 10 L tanks only (due to water volume restriction).

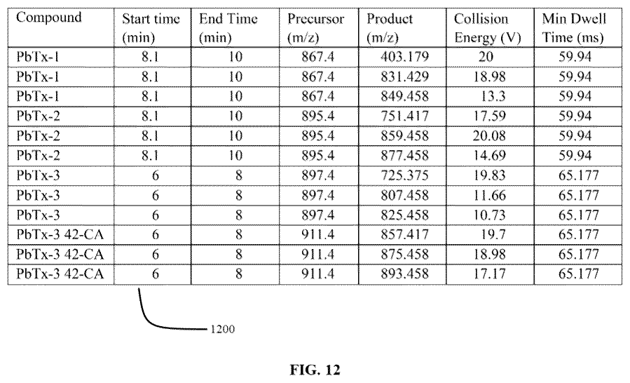

Prior to sampling, each treatment was stirred gently with a glass pipette. Water quality parameters (temperature, salinity, pH, and dissolved oxygen) were measured at each sampling time point with a calibrated multimeter (YSI ProDSS, Xylem, Yellow Springs, OH, USA) in all experiments. Approximately 60 mL of water was collected and apportioned into a clean scintillation vial (10 mL) for determination of cell abundance and into clean glass bottles (50 mL) for brevetoxin analysis. Once collected, samples were counted live after staining with neutral red and/or preserved (˜1% Utermohl's solution) in glass scintillation vials and stored in the dark until analysis. Cells of K. brevis were counted using a Sedgwick-Rafter counting chamber and a Zeiss PrimoStart Microscope. Brevetoxins were extracted from 50 mL aliquots of water using Strata C-18 cartridges (Phenomenex, Torrance, CA, USA) in a PromoChrom SPE-03 automated sample preparation system (PromoChrom, Cincinnati, OH, USA). Intracellular toxins (BTX-1, BTX-2) and two major degradation products (BTX-3, BTX-B5) were quantified by HPLC-MS/MS analysis using a Vanquish HPLC system coupled to a TSQ Quantis triple quadrupole (TQ) mass spectrometer equipped with an electrospray interface (LC/ESI/MS/MS) (Thermo Fisher Scientific Inc., Waltham, MA, USA). Chromatographic separation was performed on a Hypersil Gold Vanquish Aq UHPLC C18 reversed phase polar end-capped column at 30° C. (1.9 μm particle size, 100 mm×2.1 mm ID; Thermo Fisher Scientific Inc., Waltham, MA, USA). The mobile phase consisted of water fortified with 0.1% formic acid (solvent A) and acetonitrile fortified with 0.1% formic acid (solvent B). Gradient elution consisted of a solution of 50:50 (v/v) (A:B) for 1 min, followed by a linear increase in solvent B to 95% over 9 min. After achieving this composition, solvent B was reduced back to initial conditions over a period of 1 min, and this was held for the remaining 4 min of the method. The injection volume was 5 μL and the flow-rate was 200 μL/min throughout the entire 15 min gradient. Ionization in the ESI source was achieved using nitrogen as a nebulizer and drying gas. ESI source spray voltage was 4200 V positive mode only, the ion transfer capillary temperature was 350° C., the vaporization temperature was 75° C., and the sheath gas, auxiliary and sweep gas pressure were 30, 5 and 0, respectively, in arbitrary units used by Thermo Scientific. A multiple reaction monitoring method was used with collision-induced dissociation (CID) using argon as the collision gas at a fixed pressure of 1.5 mTorr and a cone voltage that was optimized for each individual compound (FIG. 12 and table 1200). Commercially available reference standards (BTX-1, BTX-2, BTX-3 and BTX-B5; MARBIONC University of North Carolina, Wilmington, NC, USA) were used for instrument calibration and extraction and analyses quality. Samples for dissolved ammonium (DNH₄—N), nitrite-nitrate (DNO_{2,3}—N), and phosphate (DPO₄—P) were filtered through Pall Supor 450 0.45 μm membrane filters immediately after sample collection and analyzed within 24 h of collection. Analyses for dissolved nutrients were conducted on an Auto Analyzer (Bran+Luebbe/Scal).

In order to compare results between experiments, given different starting K. brevis cell abundances and other differences between experiments, cell and toxin measurements were converted to percent reduction data for statistical analyses. The percent reduction (% R) in cell and toxin concentrations with additions of different concentrations of curcumin were calculated at 2, 4, 6, 24, 48, 72, and 96 h (if applicable) relative to controls. Data distributions were tested for normality and homoscedasticity according to the Shapiro-Wilk and Levene tests, respectively. Given the strong left skew of these distributions and the presence of negative values, due to the necessary use of percentages, Kruskal-Wallis and Dunn's non-parametric tests were used to examine statistical differences between experimental treatments and other parameters. Generalized Linear Models were used to visualize the data and provide estimates of confidence intervals. Data analyses were performed using R.

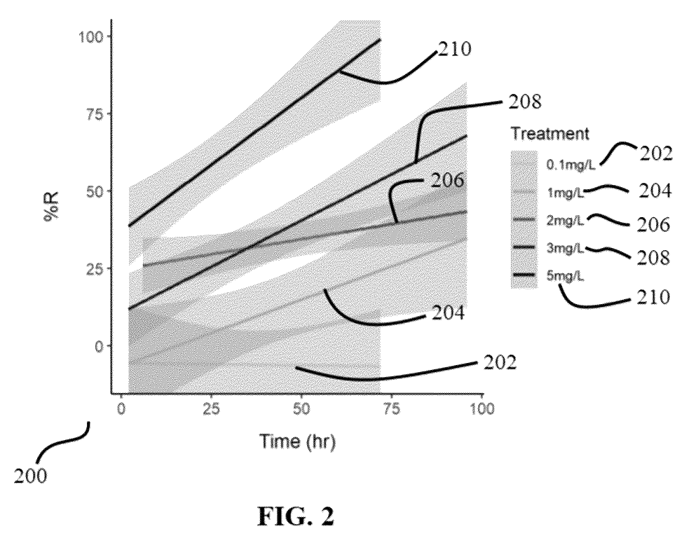

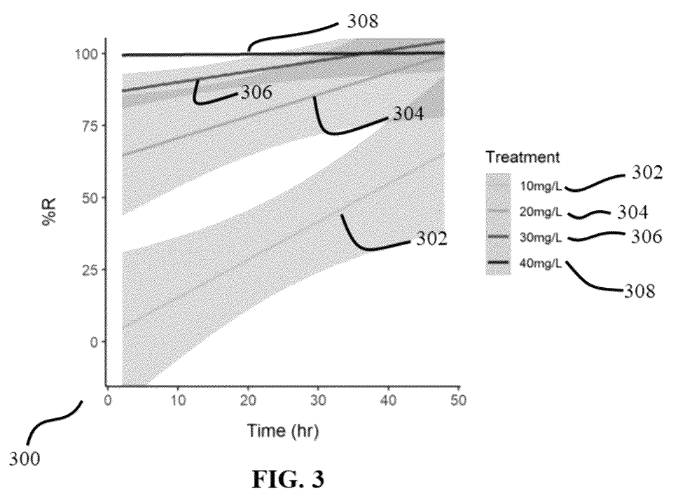

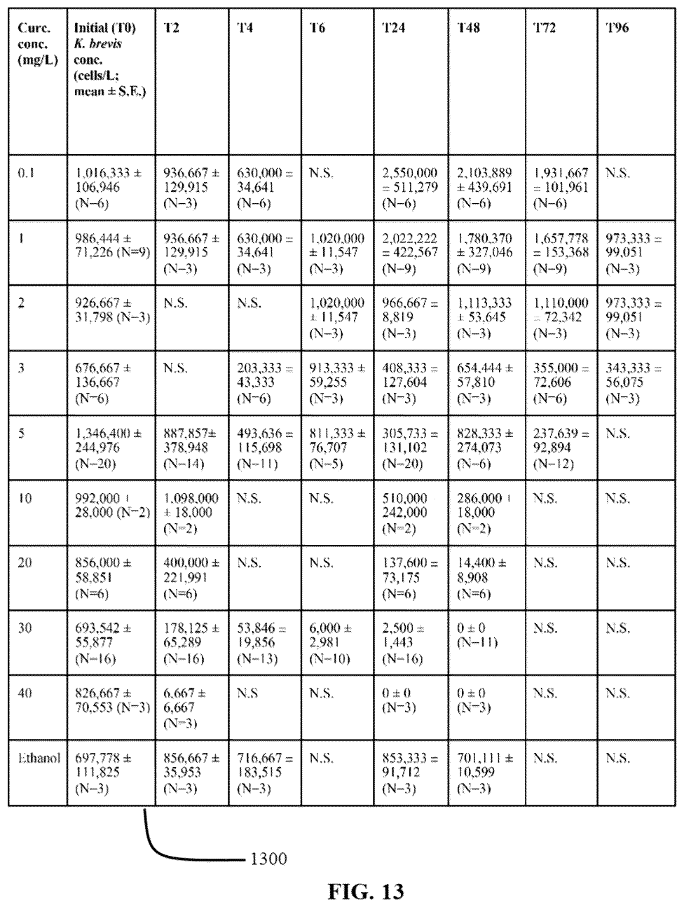

The abundance of K. brevis throughout each experiment is presented in table 1300 of FIG. 13. A target initial cell abundance of approximately 1,000,000 cells/L of K. brevis culture (mean±SE; 1,124,179±58,225 cells/L; FIG. 13) was used to both approximate a medium bloom abundance range and to allow for direct comparisons between experiments. In FIG. 13, S.E. is the abbreviation for standard error and N.S. is the abbreviation for not sampled. Overall, the percent reduction (% R) in K. brevis cell abundance, relative to the control, was significantly different over time and between curcumin concentrations (FIG. 2 and FIG. 3, Kruskal-Wallis p<0.001). FIG. 2 shows a graph 200 and the percent reduction (% R) of low-dose (0.1-5 mg/L) curcumin treatments on K. brevis cell abundance (cells/L) relative to control. Lines represent mean±95% CI from additive GLM of time and treatment as explanatory variables. N varies by treatment and time point, N=3 at minimum. On FIG. 2, 202 represents 0.1 mg/L, 204 represents 1 mg/L, 206 represents 2 mg/L, 208 represents 3 mg/L, and 210 represents 5 mg/L. FIG. 3 shows a graph 300 and the production (% R) of high-dose (10-40 mg/L) curcumin treatments on K. brevis cell abundance (cells/L) relative to control. Lines represent mean±95% CI from additive GLM of time and treatment as explanatory variables. N varies by treatment and time point, N=3 at minimum. On FIG. 3, 302 represents 10 mg/L, 304 represents 20 mg/L, 306 represents 30 mg/L, and 308 represents 40 mg/L.

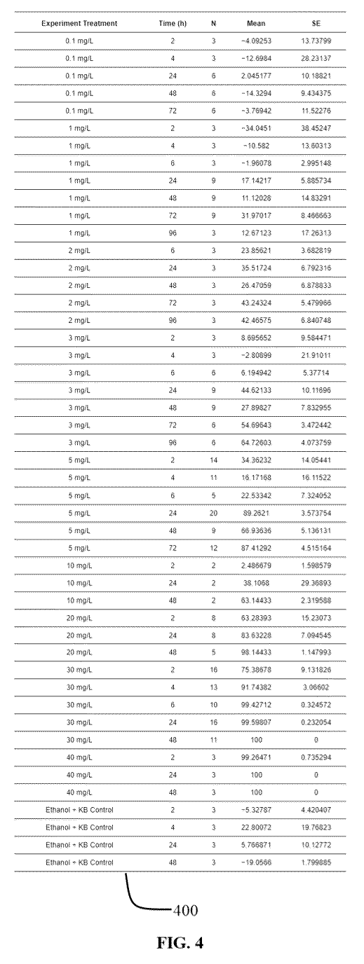

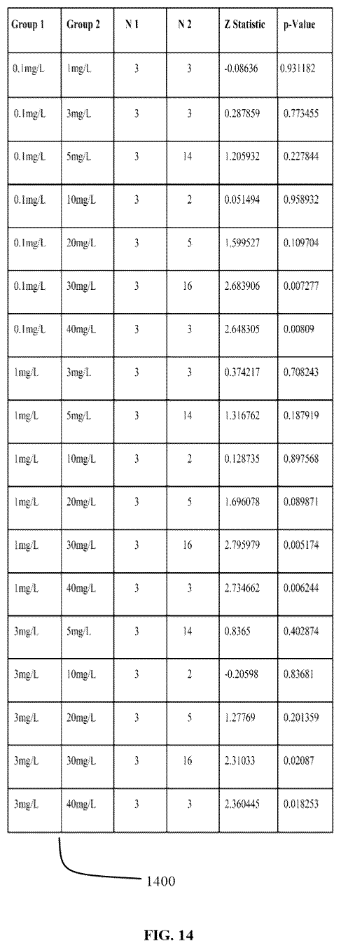

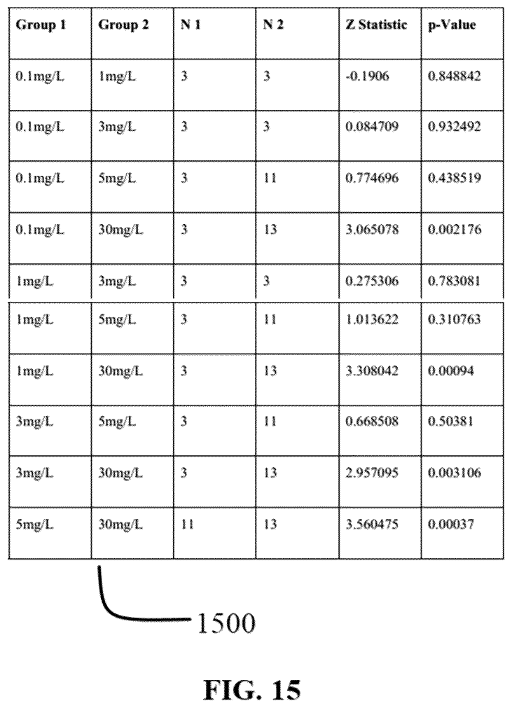

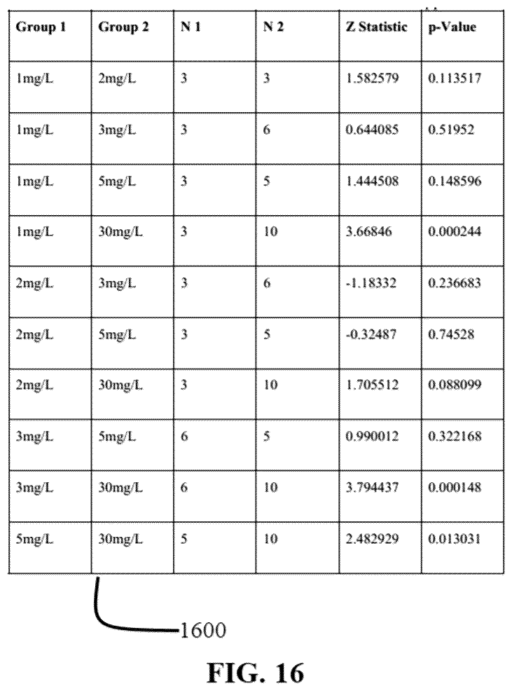

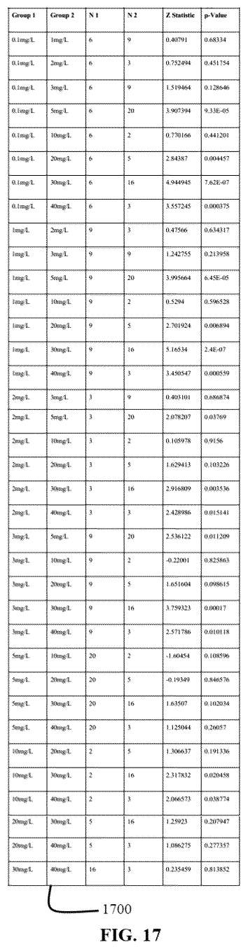

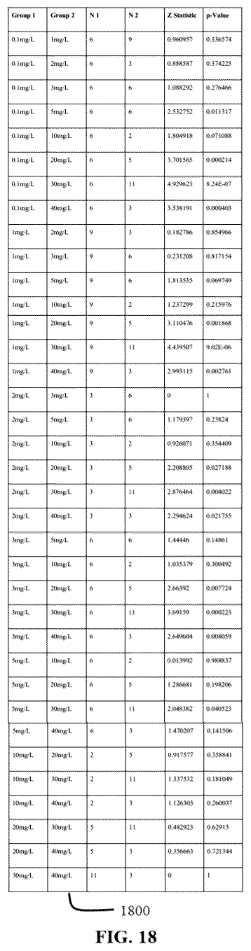

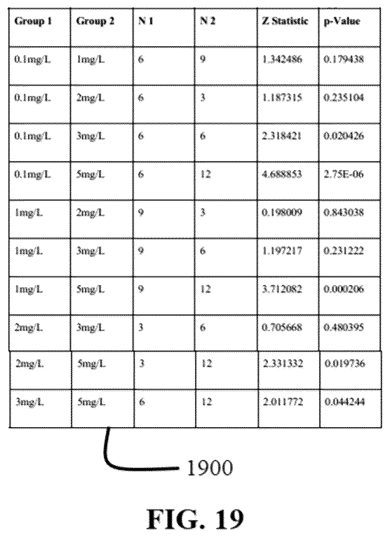

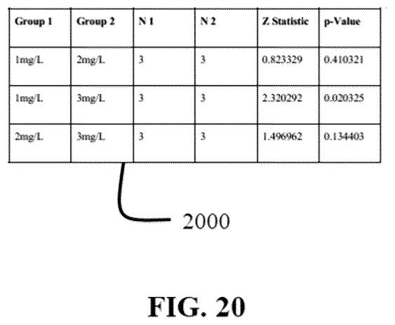

Within the lower concentration tests (0.1-5 mg/L curcumin), no significant differences were found in % R between 0.1, 1, or 2 mg/L curcumin treatments at any time point (FIG. 2 and FIGS. 14-20, Dunn's tests p>0.05). Treatments of 3 mg/L began to show significantly greater reduction over 0.1 mg/L starting at 72 h (FIG. 19, Dunn's test p<0.05), and greater reduction over 1 mg/L at 96 h (FIG. 20, Dunn's test p<0.05). Treatments of 5 mg/L began to show significantly greater reduction over all lower concentrations beginning at 24 h (FIG. 17, Dunn's test p<0.05). At 24 h, the mean % R with 5 mg/L was 89.26%+3.57 SE, compared to 3 mg/L at 44.62%+10.12 SE (FIG. 4, table 400).

FIG. 4 shows the mean and standard error of percent reduction (% R) of curcumin treatments on K. brevis cell abundance relative to control by sample event. Within the higher concentration tests (10-40 mg/L curcumin), post hoc analyses found no significant differences between 5, 10, and 20 mg/L curcumin treatments at any time point (FIGS. 3 and 13-19, Dunn's tests p>0.05). The two highest concentrations (30 and 40 mg/L) were not significantly different from each other at any time point (Dunn's tests, p>0.05), with mean % R>90% beginning at 4 h (FIG. 4), and had significantly higher reduction rates than lower concentrations (0.1-5.0 mg/L curcumin) beginning at 2 h (Dunn's tests, p<0.05).

One experiment was conducted with a control group containing K. brevis and ethanol without curcumin to examine the potential contribution of the solvent to reduction rates. % R of the ethanol control, relative to 0 h, did not significantly differ from the K. brevis control (Kruskal-Wallis p=0.77), and did not significantly differ over time (p=0.08), indicating little impact of the solvent on cell abundance.

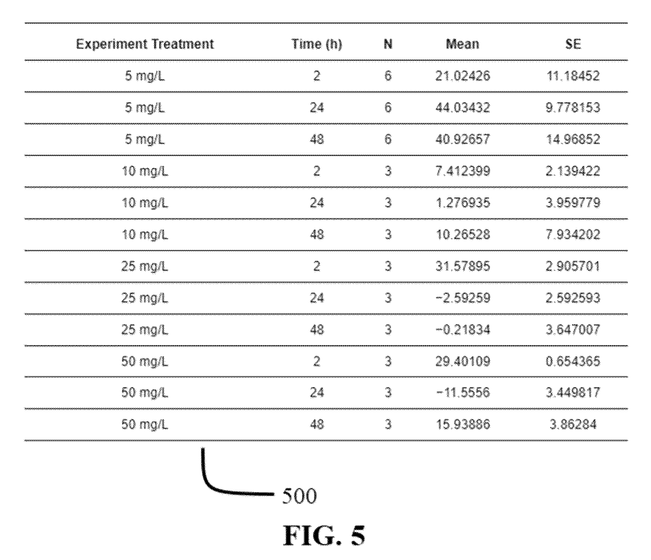

White curcumin (CuroWhite and Zedoary Root) failed to achieve >50% reduction at any time point at any concentration investigated (5-50 mg/L, FIG. 5, table 500). The performance of white curcumin was therefore determined to be unsatisfactory, and these products were not explored further. FIG. 5 shows the mean and standard error of percent reduction (% R) of curcumin treatments on K. brevis cell abundance relative to control by sample event for white curcumin only.

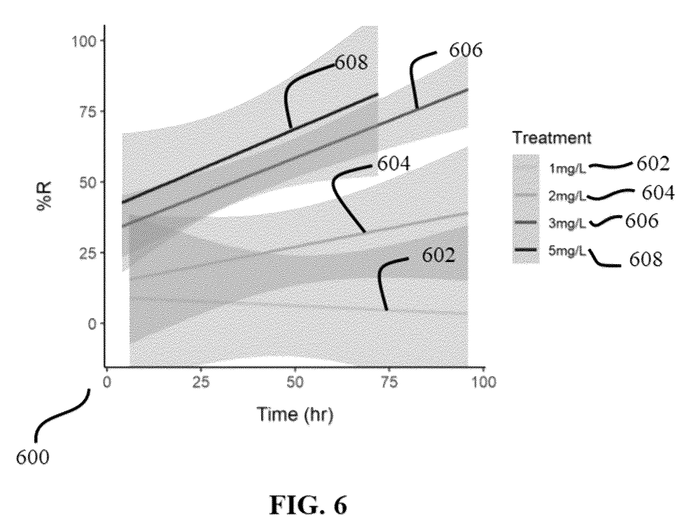

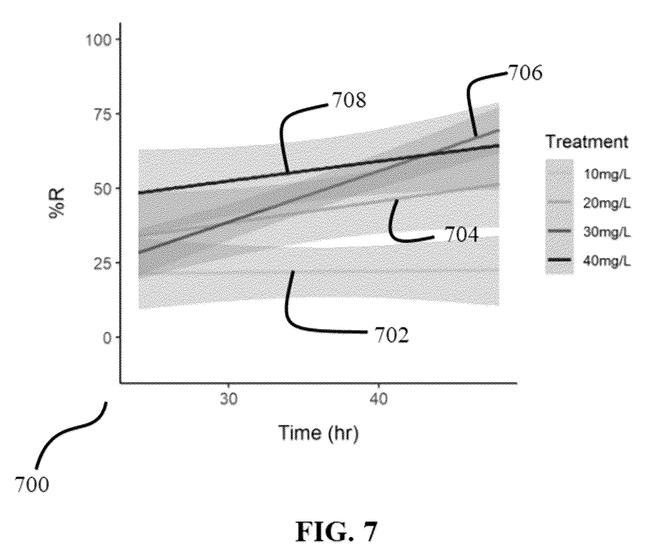

Statistical analyses for total K. brevis toxins were conducted on the sums of the four brevetoxin analogs measured: BTX-1, BTX-2, BTX-3, and BTX-B5. For 1, 2, 3, and 5 mg/L curcumin treatments, measurements of toxins were taken between 0 and 96 h. For 10, 20, 30, and 40 mg/L, measurements were taken at 24 and 48 h only. Overall, the percent reduction (% R) in total toxins, relative to control, were significantly different over time (FIG. 6 and FIG. 7, Kruskal-Wallis p=0.05) and between curcumin concentrations (Kruskal-Wallis p<0.0001). FIG. 6 shows the percent reduction (% R) of low-dose (1-5 mg/L) curcumin treatments on K. brevis total toxins relative to control. Lines represent mean±95% CI from additive GLM of time and treatment as explanatory variables. Total toxin measurements are sums of brevetoxin analogs BTX-1, BTX-2, BTX-3, and BTX-B5 in ng/L. N varies by treatment and time point, N=3 at minimum. On the graph 600 of FIG. 6, 602 represents 1 mg/L, 604 represents 2 mg/L, 606 represents 3 mg/L, and 608 represents 5 mg/L. The graph 700 of FIG. 7 shows the percent reduction (% R) of high-dose (10-40 mg/L) curcumin treatments on K. brevis total toxins relative to control. Lines represent mean±95% CI from additive GLM of time and treatment as explanatory variables. Total toxin measurements are sums of brevetoxin analogs BTX-1, BTX-2, BTX-3, and BTX-B5 in ng/L. N varies by treatment and time point, N=2 at minimum. On FIG. 7, 702 represents 10 mg/L, 704 represents 20 mg/L, 706 represents 30 mg/L, and 708 represents 40 mg/L.

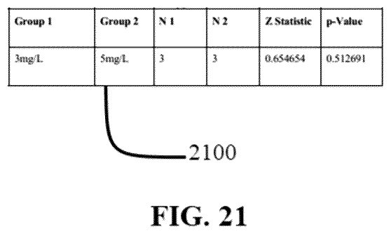

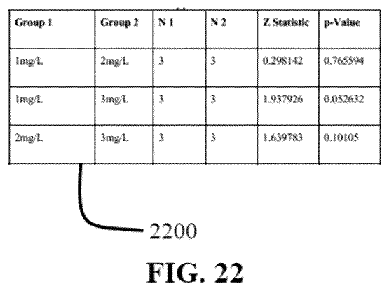

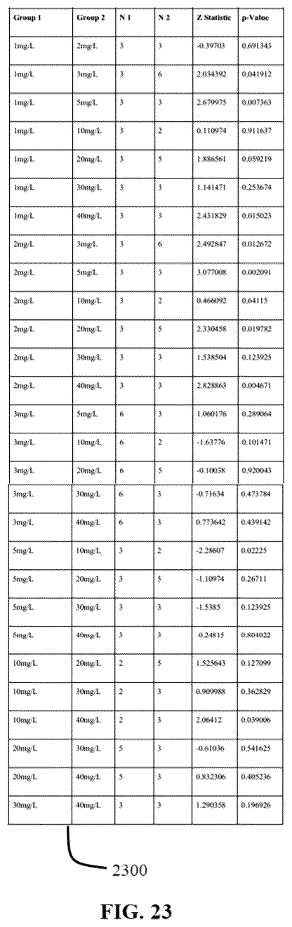

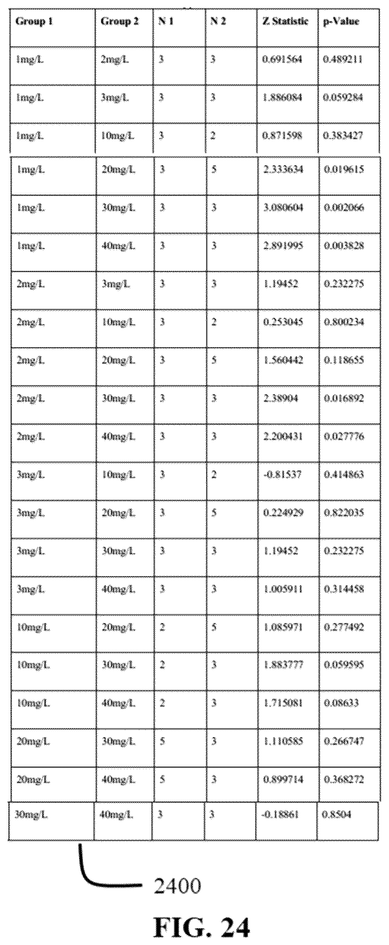

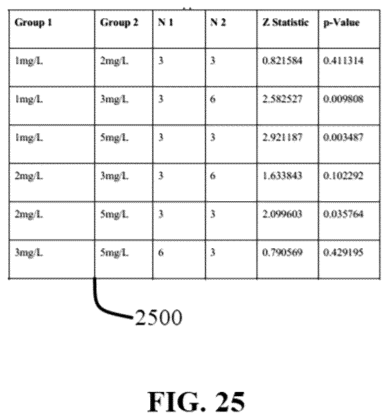

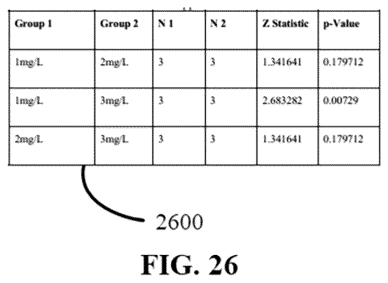

Within the lower concentration tests (1-5 mg/L curcumin), no significant differences in % R between 1 or 2 mg/L curcumin concentrations were found at any time point (FIG. 6 and FIGS. 21-26, Dunn's tests p>0.05). Concentrations of 3 and 5 mg/L began to show significantly greater reduction over 1 and 2 mg/L beginning at 24 h (FIG. 23, Dunn's test p<0.05), but were not significantly different from each other at any time point. At 72 h, the mean % R with 2 mg/L was 41.94%+1.71 SE, compared to 5 mg/L at 79.28%+2.33 SE (FIG. 6).

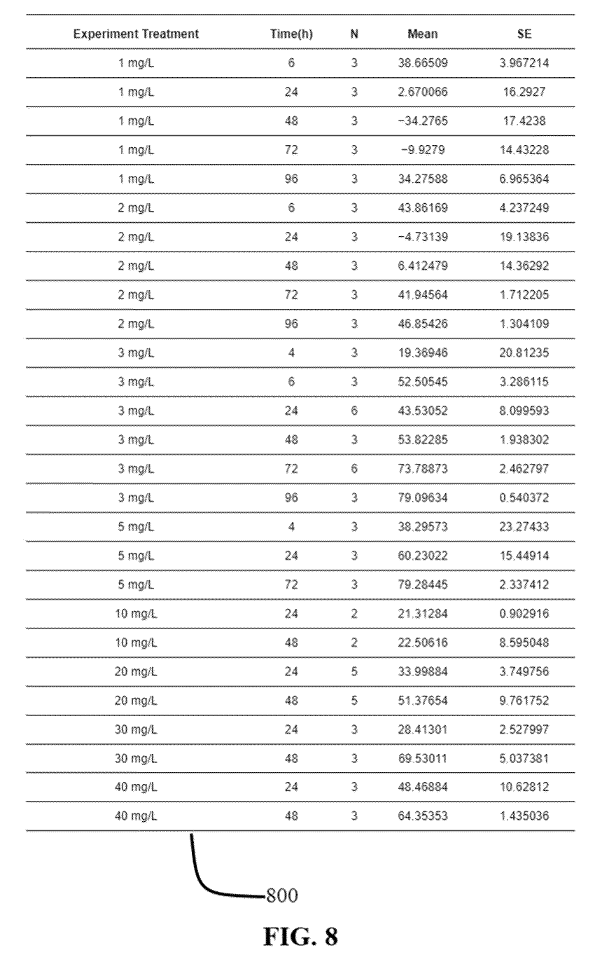

The table 800 of FIG. 8 shows the mean and standard error of percent reduction (% R) of curcumin treatments on K. brevis toxins (sum of analogs BTx-1, BTx-2, BTx-3, and BTx-B5 in ng/L) relative to control by sample event.

Considerable overlap in toxin reduction performance was seen between low and high curcumin dosages, indicating a weaker relationship compared to cell reduction. Within the higher concentration tests (10-40 mg/L curcumin), post hoc analyses found no significant differences in % R between 3, 5, 20, 30, and 40 mg/L curcumin treatments at either 24 or 48 h (FIG. 7 and FIGS. 22-23, Dunn's tests p>0.05). Brevetoxin concentrations after curcumin dosage of 10 mg/L did not differ from 1, 2, or 3 mg/L at either time point, and performed significantly lower than 40 mg/L at both time points. Within the highest concentration, 40 mg/L, the mean % R was 64.35%+1.43 SE at 48 h. However, the highest % R overall was seen with 5 mg/L at 72 h, at 79.28%+2.33 SE.

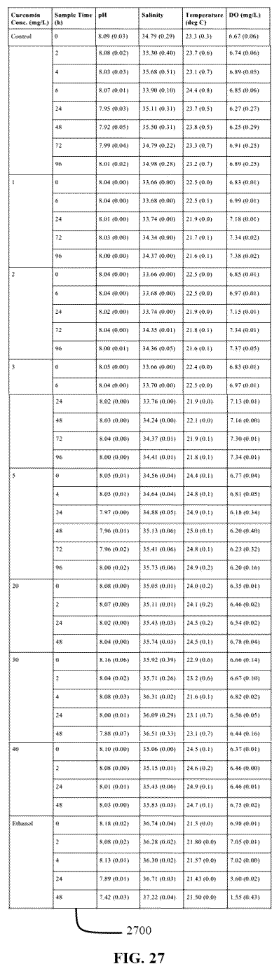

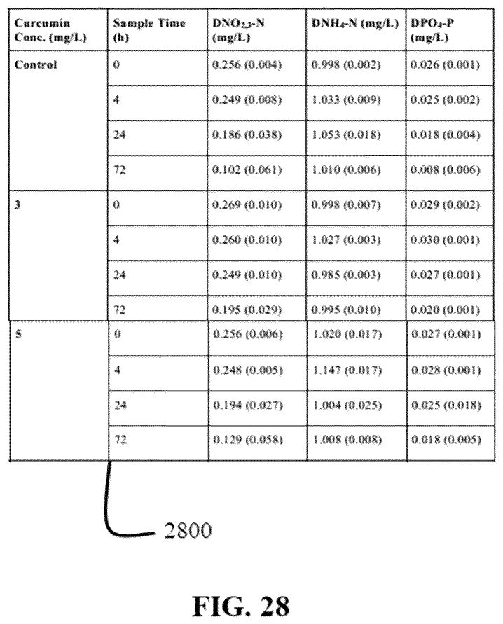

Water quality parameters (pH, salinity, temperature, dissolved oxygen) occurred within narrow ranges and showed little variation throughout each study, with the exception of dissolved oxygen (DO) in the ethanol test. All water quality data are presented in FIG. 27. At T48, DO dropped from 6-7 mg/L to 1.55 mg/L and was likely due to a bacterial bloom. Nutrients (dissolved ammonium (DNH₄—N), nitrate-nitrite (DNO_{2,3}—N) and phosphate (DPO₄—P)) were only measured throughout laboratory tests that were performed in containers greater than 10 L (3 and 5 mg/L curcumin) due to the volume required for analyses. There were no significant differences (ANOVA on ranks; DNO_{2,3}—N, p=0.957; DNH₄—N, p=0.095; DPO₄—P, p=0.95) between nutrient concentrations throughout or between experiments (FIG. 28).

Investigation of compounds and technologies for the mitigation of K. brevis blooms are currently under investigation and scrutiny with the understanding that the mitigation product should be effective against K. brevis cells and brevetoxins, and not be more harmful to the environment than an untreated bloom. Curcumin is commercially available, has been widely used in aquaculture, food, cosmetics and pharmaceuticals and has been tested as an anti-parasitic, anti-algal compound on other HABs and pests. To the authors' knowledge, no other mitigation studies have been conducted on K. brevis mitigation using curcumin. In this study, curcumin displayed the ability to eliminate cells of K. brevis, reduce total brevetoxins, and have little to no impact on water quality in laboratory mitigation testing. A focus on laboratory mitigation studies prior to in situ deployment within a bloom allows for evaluation of a range of concentrations that might be efficient at reducing the intended organism. The minimum concentration of curcumin for a reduction in K. brevis in our study was 5 mg/L (89-90% at T24); however, the best mitigation results occurred with higher curcumin concentrations of 20-40 mg/L (60-100% at T2-T6).

The mechanism of K. brevis destruction by curcumin was not evaluated in this study, yet it will be important to determine long-term efficacy as a mitigation product. Curcumin, is a photocatalyst and is a known scavenger of reactive oxygen species (ROS) that mainly accumulate in chloroplast and mitochondrial electron transport chains of phytoplankton, yet may also increase ROS. When ROS is elevated, it serves as an intracellular signal to activate caspase-like activity in phytoplankton cells, leading to reduced chlorophyll a and cell death. Other studies have found that potential mitigation products such as dibutyl phthalate inhibit cell growth, decrease cell abundance, reduce chlorophyll a, and cause oxidative stress to K. brevis by causing overproduction of ROS. Photocatalytic methods are based on the interaction between molecular oxygen and a photocatalyst agent (such as curcumin) that produces ROS that can kill target organisms by oxidizing them.

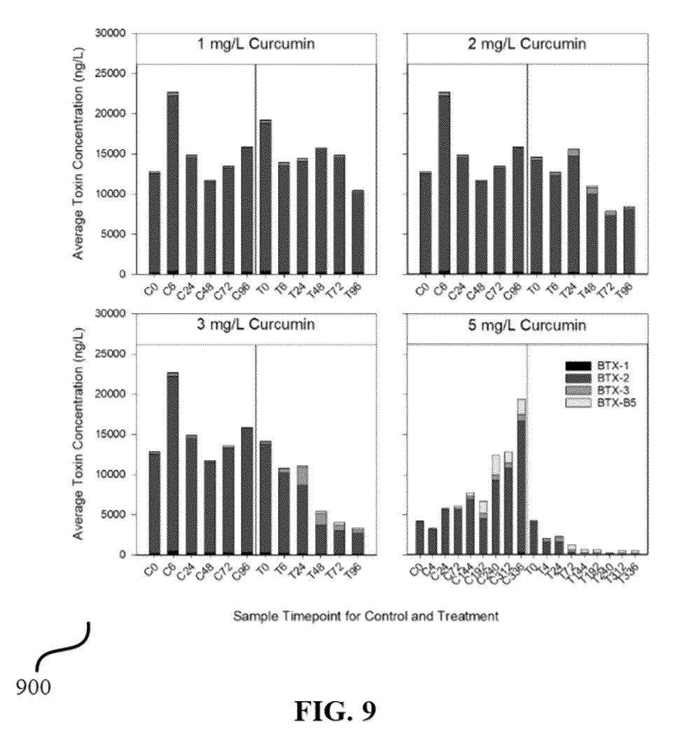

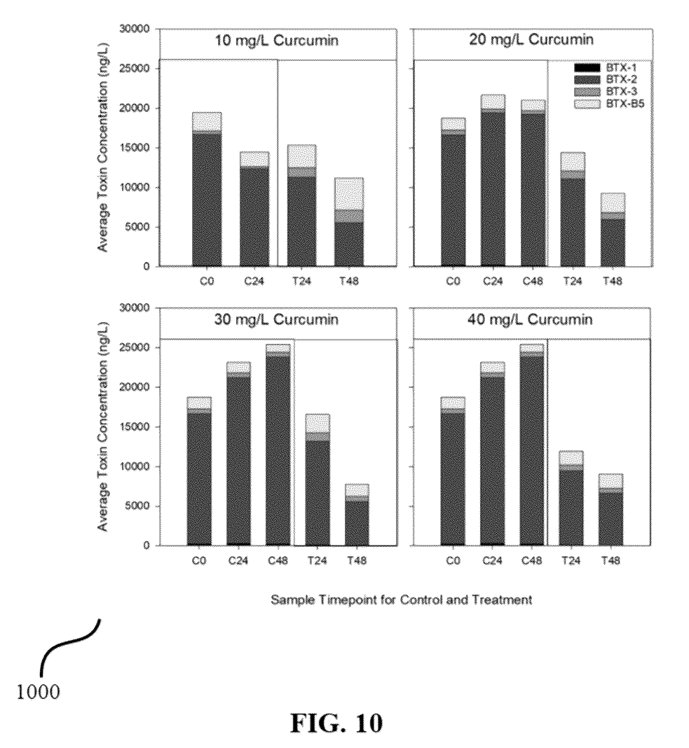

A reduction in and/or the destruction of HAB cells alone is insufficient to mitigate a HAB bloom. Cell death can also release additional toxins, so eliminating toxins is also important when determining the efficacy of a mitigation compound or technology. Yuan et al. found that 80 mmol/L curcumin mixture inhibits accumulation of diarrheal shellfish toxins from an epibenthic dinoflagellate (Prorocentrum lima) by inhibiting activity of uptake genes. In our study, total brevetoxins (in seawater) were significantly reduced by 48 h post treatment in curcumin concentrations greater than 3 mg/L and by 24 h in concentrations from 5 to 40 mg/L. The suite of brevetoxins in seawater during and after a bloom consists of intra-cellular (BTX-1, BTX-2) and extra-cellular (BTX-3, BTX-B5) toxins. BTX-1 and BTX-2 are made of similar, yet distinct polycyclic ether backbones, while the rest of the brevetoxins are thought to be metabolic derivatives, or oxidation products, of these two parent compounds. Interestingly, parent toxins were not typically converted to analog forms over time with curcumin treatment (graphs 900 of FIG. 9 and graphs 1000 of FIG. 10). This is unlike other mitigation strategies such as modified PAC clay where parent toxins were modified, indicative of dying K. brevis cells. It is possible that due to its scavenging properties on oxygen, curcumin prevented the conversion into metabolites.

FIG. 9 shows the total brevetoxin concentrations (ng/L) in low (1-5 mg/L)-dose treatments over time divided by congener: BTX-1, BTX-2, BTX-3, and BTX-B5. In the x-axis, C indicates control treatment (no curcumin addition), while T indicates curcumin treatment, with the number of hours post addition indicated after the letter. N varies by treatment and time point, N=3 at minimum.

FIG. 10 depicts the total brevetoxin concentrations (ng/L) in high (10-40 mg/L)-dose treatments over time divided by congener: BTX-1, BTX-2, BTX-3, and BTX-B5. In the x-axis, C indicates control treatment (no curcumin addition), while T indicates curcumin treatment, with the number of hours post addition indicated after the letter. N varies by treatment and time point, N=2 at minimum.

Curcumin is a naturally orange-yellow organic molecule that readily turns seawater a light yellow or dark orange color depending on concentration. Karenia brevis blooms can also turn seawater a dark red or brown color. If the concentration of curcumin used for mitigation does not exceed the already impacted color from a K. brevis bloom (or if color is diluted with the application of the product), then the coloring effect may be minimal or go unnoticed. There are currently no restrictions on color according to the EPA Clean Water Act for Class II water bodies (which includes estuarine environments such as Sarasota Bay).

During studies, curcumin was mixed with deionized water, filtered seawater, a small percent of ethanol (0.001-0.004%), and 99.9% ethanol. Some studies have dissolved curcumin in absolute ethanol, or dissolved very small amounts in NaOH. Other studies have used DMSO as a solvent. Low concentrations (e.g., 0.004%) of ethanol did not negatively impact K. brevis growth. Carrier solvent can be scaled up to improve effectiveness. The shelf life of store-bought curcumin is limited to a few years, even when stored in sealed containers in low light; however, the cost of 99.5% powdered curcumin is approximately USD 100/kg, so if stored properly, it is a relatively economical solution.

Methods of distribution of curcumin as a mitigation product on K. brevis blooms may also be considered. Solubility, optimum dose, dispersal method, spatial distribution, and the number of dispersals may be considered per bloom event. Strategies for application of other HAB mitigation compounds include surface spraying (e.g., clay), pellet distribution, distribution via air, and in-water distribution. Tidal cycles are also important to evaluate. Typical tidal cycles in and around estuaries where K. brevis is often found (e.g., Sarasota Bay, Florida) depends on navigation channels, the number of inlets, and bathymetry. Karenia brevis blooms are not typically associated with tidal movement; however, mitigation product deployment may be, depending on water turnover time, solubility, density, etc.

As such, curcumin may be a cost-effective way to treat K. brevis blooms. In laboratory studies, lower dose concentrations of curcumin (0.1-5 mg/L) were less effective against K. brevis compared to higher concentrations (10-40 mg/L). There were also no significant impacts on water quality in these controlled studies.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A method for harmful algal bloom (HAB) mitigation, the method comprising:
preparing a HAB mitigation substance comprising a curcuminiod substance; and
applying the HAB mitigation substance to a HAB to destroy algal cells within the HAB and prevent or inhibit release of toxins from the algal cells.

2. The method of claim 1, wherein preparing the HAB mitigation substance comprises subjecting the curcuminoid substance to a solubility process to increase a solubility of the HAB mitigation substance.

3. The method of claim 1, wherein preparing the HAB mitigation substance comprises subjecting the curcuminoid substance to a flocculant distribution process comprising mixing the curcuminoid substance with a flocculant to distribute the curcuminoid substance throughout the flocculant to form the HAB mitigation substance.

4. The method of claim 3, wherein the flocculant comprises a clay minerals or a modified clay.

5. The method of claim 1, wherein the curcuminoid substance comprises curcumin.

6. The method of claim 1, wherein the curcuminoid substance comprises phytochemical curcumin, (1E,6E)-1,7-Bis (4 (hydroxy-3-methoxyphenyl)-1,6-heptadiene-3,5-dione).

7. The method of claim 1, wherein the curcuminoid substance comprises turmeric extract powder, zedoary root, or a hydrogenated form of Curcuma longa.

8. The method of claim 1, wherein the algal cells are Karenia brevis cells.

9. The method of claim 1, wherein applying the HAB mitigation substance comprises surface vessel spraying, airborne spraying, or submerged vessel spraying.
